(19) United States
(12) Patent Application Publication
(10) Pub. No.: US 2024/0244219 A1
(43) Pub. Date: Jul. 18, 2024

(54) METHOD, DEVICE, AND MEDIUM FOR VIDEO PROCESSING

(71) Applicant: Bytedance Inc., Los Angeles, CA (US)

(72) Inventor: Ye-Kui WANG, Los Angeles, CA (US)

(21) Appl. No.: 18/618,836

(22) Filed: Mar. 27, 2024

Related U.S. Application Data
(63) Continuation of application No. PCT/US2022/077048, filed on Sep. 26, 2022.
(60) Provisional application No. 63/248,852, filed on Sep. 27, 2021.

(51) Int. Cl. H04N 19/136; H04N 19/169; H04N 19/172; H04N 19/46

(52) U.S. Cl. CPC H04N 19/136; H04N 19/172; H04N 19/188; H04N 19/46

(57) ABSTRACT

Embodiments of the present disclosure provide a solution for video processing. A method for video processing is proposed. The method comprises: receiving, by a first device, a metadata file from a server; and determining, from the metadata file, a list of region identities (IDs) for indicating a first set of coded video data units in each picture of a first video representing a target picture-in-picture region which is able to be replaced by a second set of coded video units in a second video.

### CROSS REFERENCE TO RELATED APPLICATIONS

This application is a continuation of International Application No. PCT/US2022/077048, filed on Sep. 26, 2022, which claims the benefit of U.S. Application No. 63/248,852 filed on Sep. 27, 2021. The entire contents of these applications are hereby incorporated by reference in their entireties.

### FIELD

Embodiments of the present disclosure relates generally to video coding techniques, and more particularly, to generation, storage and consumption of digital audio video media information in a file format.

### BACKGROUND

Media streaming applications are typically based on the internet protocol (IP), transmission control protocol (TCP), and hypertext transfer protocol (HTTP) transport methods, and typically rely on a file format such as the ISO base media file format (ISOBMFF). One such streaming system is dynamic adaptive streaming over HTTP (DASH). In Dynamic adaptive streaming over HTTP (DASH), there may be multiple representations for video and/or audio data of multimedia content, different representations may correspond to different coding characteristics (e.g., different profiles or levels of a video coding standard, different bitrates, different spatial resolutions, etc.). Moreover, a technology named “picture-in-picture” has been proposed. Therefore, it is worth studying on DASH supporting picture-in-picture services.

### SUMMARY

Embodiments of the present disclosure provide a solution for video processing.

In a first aspect, a method for video processing is proposed. The method comprises: receiving, at a first device, a metadata file from a second device; and determining, from the metadata file, a list of region identities (IDs) for indicating a first set of coded video data units in each picture of a main video representing a target picture-in-picture region which is replaceable by a second set of coded video units in a supplementary video. In this way, the first device knows which coded video data units in each picture of the first video represent the target picture-in-picture region and can perform the replacement.

In a second aspect, another method for video processing is proposed. The method comprises: determining, at a second device, a metadata file, the metadata file comprising a list of region identities (IDs) for indicating a first set of coded video data units in each picture of a first video representing a target picture-in-picture region which is replaceable by a second set of coded video units in a second video; and transmitting the metadata file to a first device. In this way, the first device knows which coded video data units in each picture of the first video represent the target picture-in-picture region and can perform the replacement.

In a third aspect, an apparatus for processing video data is proposed. The apparatus for processing video data comprises a processor and a non-transitory memory with instructions thereon. The instructions, upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of a picture partitioned into 18 tiles, 24 slices and 24 subpictures;

FIG. 5 illustrates a schematic diagram of a typical subpicture-based viewport-dependent 360° video delivery scheme;

FIG. 6 illustrates a schematic diagram of extraction of one subpicture from a bitstream containing two subpictures and four slices;

FIG. 7 illustrates a schematic diagram of picture-in-picture support based on VVC subpictures;

FIG. 8 illustrates a flowchart of a method according to embodiments of the present disclosure;

FIGS. 9A and 9B illustrate schematic diagrams of picture-in-picture;

FIG. 10 illustrates a flowchart of a method according to embodiments of the present disclosure; and

FIG. 11 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

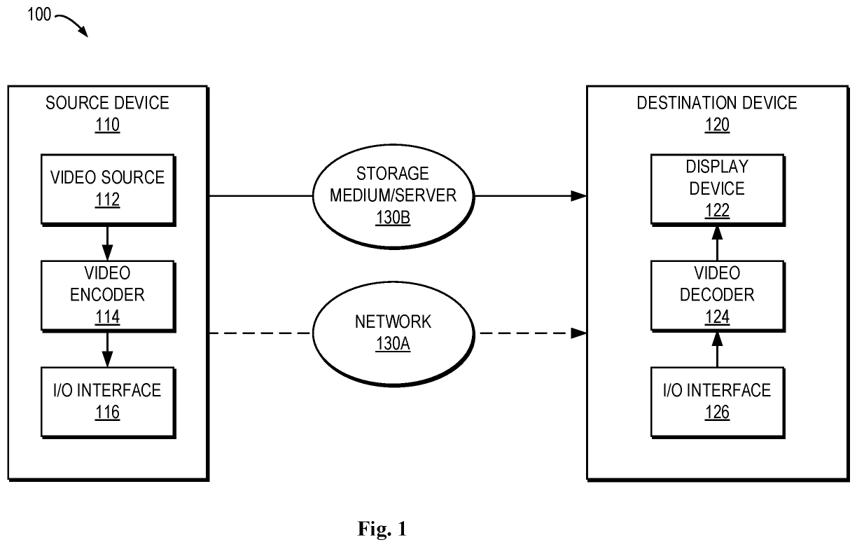

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

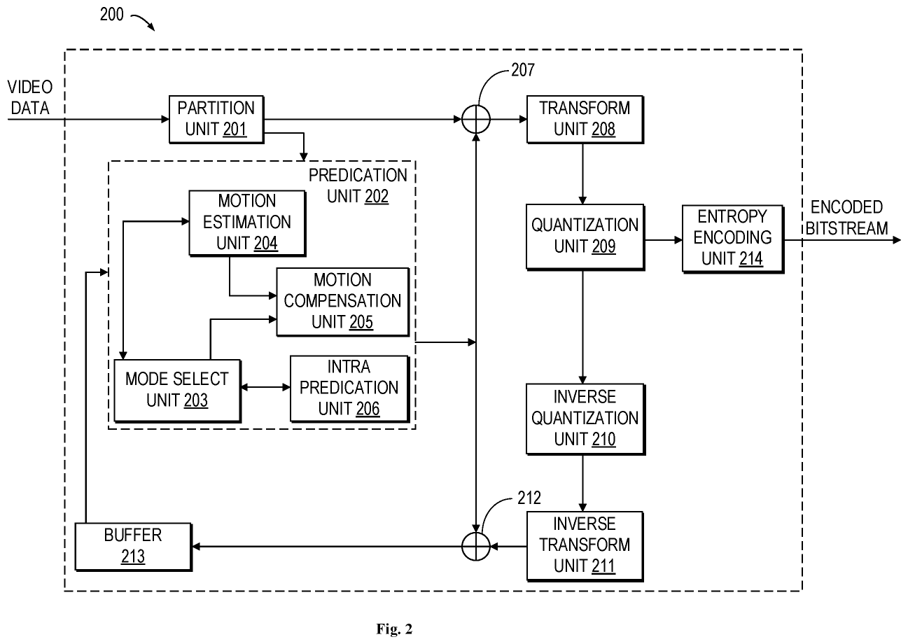

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

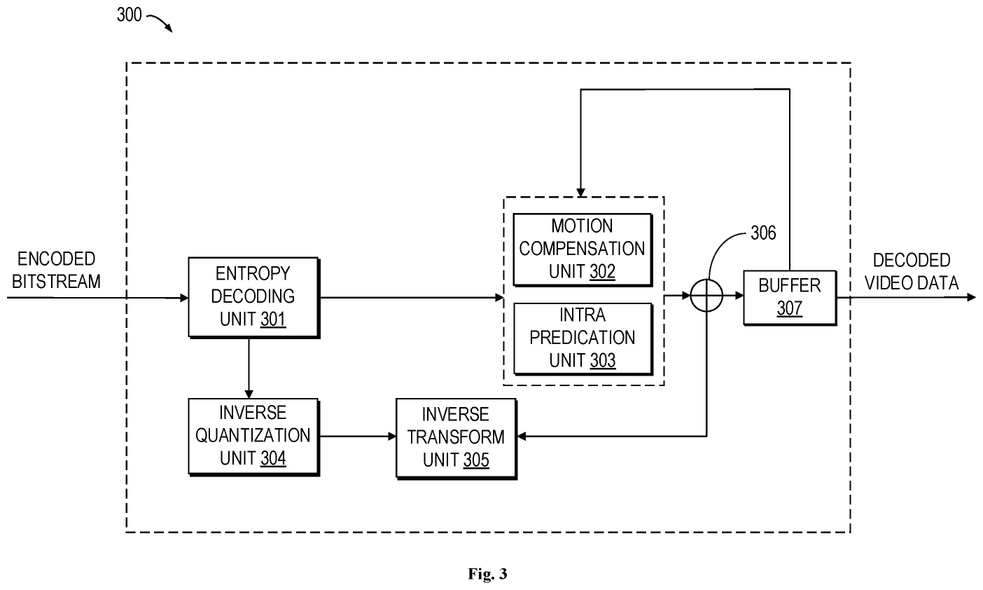

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

Embodiments of the present disclosure are related to video streaming. Specifically, it is related to the support of picture-in-picture services in Dynamic Adaptive Streaming over HTTP (DASH) via a new descriptor. The ideas may be applied individually or in various combinations, for media streaming systems, e.g., based on the DASH standard or its extensions.

### 2. Background

### 2.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended on Jul. 1, 2020.

The Versatile Video Coding (VVC) standard (ITU-T H.266|ISO/IEC 23090-3) and the associated Versatile Supplemental Enhancement Information (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 2.2. File Format Standards

Media streaming applications are typically based on the IP, TCP, and HTTP transport methods, and typically rely on a file format such as the ISO base media file format (ISOBMFF). One such streaming system is dynamic adaptive streaming over HTTP (DASH). For using a video format with ISOBMFF and DASH, a file format specification specific to the video format, such as the AVC file format and the HEVC file format in ISO/IEC 14496-15: “Information technology—Coding of audio-visual objects—Part 15: Carriage of network abstraction layer (NAL) unit structured video in the ISO base media file format”, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session.

Similarly, for using an image format with ISOBMFF, a file format specification specific to the image format, such as the AVC image file format and the HEVC image file format in ISO/IEC 23008-12: “Information technology—High efficiency coding and media delivery in heterogeneous environments—Part 12: Image File Format”, would be needed.

The VVC video file format, the file format for storage of VVC video content based on ISOBMFF, is currently being developed by MPEG. The latest draft specification of the VVC video file format is included in ISO/IEC JTC 1/SC 29/WG 03 output document N0035, “Potential improvements on Carriage of VVC and EVC in ISOBMFF”.

The VVC image file format, the file format for storage of image content coded using VVC, based on ISOBMFF, is currently being developed by MPEG. The latest draft specification of the VVC image file format is included in ISO/IEC JTC 1/SC 29/WG 03 output document N0038, “Information technology—High efficiency coding and media delivery in heterogeneous environments—Part 12: Image File Format—Amendment 3: Support for VVC, EVC, slideshows and other improvements (CD stage)”.

### 2.3. Dash

In Dynamic adaptive streaming over HTTP (DASH), there may be multiple representations for video and/or audio data of multimedia content, different representations may correspond to different coding characteristics (e.g., different profiles or levels of a video coding standard, different bitrates, different spatial resolutions, etc.). The manifest of such representations may be defined in a Media Presentation Description (MPD) data structure. A media presentation may correspond to a structured collection of data that is accessible to DASH streaming client device. The DASH streaming client device may request and download media data information to present a streaming service to a user of the client device. A media presentation may be described in the MPD data structure, which may include updates of the MPD.

A media presentation may contain a sequence of one or more periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period. A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

A typical DASH streaming procedure is shown by the following steps:
1) The client gets the MPD.
2) The client estimates the downlink bandwidth, and selects a video representation and an audio representation according to the estimated downlink bandwidth and the codec, decoding capability, display size, audio language setting, etc.
3) Unless the end of the media presentation is reached, the client requests media segments of the selected representations and presents the streaming content to the user.
4) The client keeps estimating the downlink bandwidth. When the bandwidth changes to a direction (e.g., becomes lower) significantly, the client selects a different video representation to match the newly estimated bandwidth, and go to step 3.

### 2.4. Picture Partitioning and Subpictures in VVC

In VVC, a picture is divided into one or more tile rows and one or more tile columns. A tile is a sequence of CTUs that covers a rectangular region of a picture. The CTUs in a tile are scanned in raster scan order within that tile.

A slice consists of an integer number of complete tiles or an integer number of consecutive complete CTU rows within a tile of a picture.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice. A subpicture contains one or more slices that collectively cover a rectangular region of a picture.

### 2.4.1. Subpicture Concept and Functionality

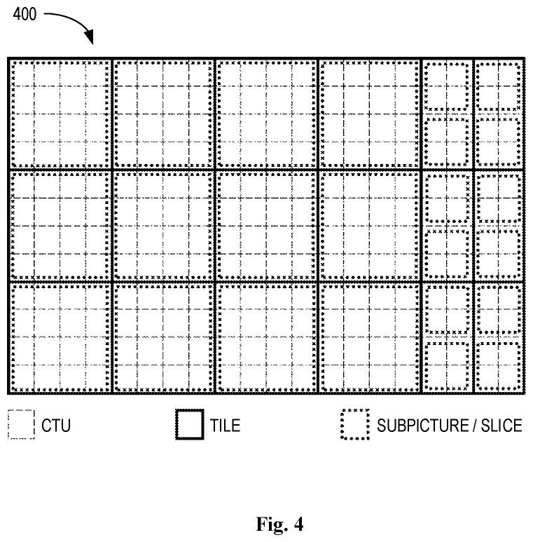

In VVC, each subpicture consists of one or more complete rectangular slices that collectively cover a rectangular region of the picture, e.g., as shown in FIG. 4. FIG. 4 illustrates a schematic diagram 400 of a picture partitioned into 18 tiles, 24 slices and 24 subpictures. A subpicture may be either specified to be extractable (i.e., coded independently of other subpictures of the same picture and of earlier pictures in decoding order) or not extractable. Regardless of whether a subpicture is extractable or not, the encoder can control whether in-loop filtering (including deblocking, SAO, and ALF) is applied across the subpicture boundaries individually for each subpicture.

Functionally, subpictures are similar to the motion-constrained tile sets (MCTSs) in HEVC. They both allow independent coding and extraction of a rectangular subset of a sequence of coded pictures, for use cases like viewport-dependent 360° video streaming optimization and region of interest (ROI) applications.

In streaming of 360° video, a.k.a. omnidirectional video, at any particular moment only a subset (i.e., the current viewport) of the entire omnidirectional video sphere would be rendered to the user, while the user can turn his/her head anytime to change the viewing orientation and consequently the current viewport. While it is desirable to have at least some lower-quality representation of the area not covered by the current viewport available at the client and ready to be rendered to the user just in case the user suddenly changes his/her viewing orientation to anywhere on the sphere, a high-quality representation of the omnidirectional video is only needed for the current viewport that is being rendered to the user at any given moment. Splitting the high-quality representation of the entire omnidirectional video into subpictures at an appropriate granularity enables such an optimization as shown in FIG. 4 with 12 high-resolution subpictures on the left-hand side and the remaining 12 subpictures of the omnidirectional video in lower resolution on the right-hand side.

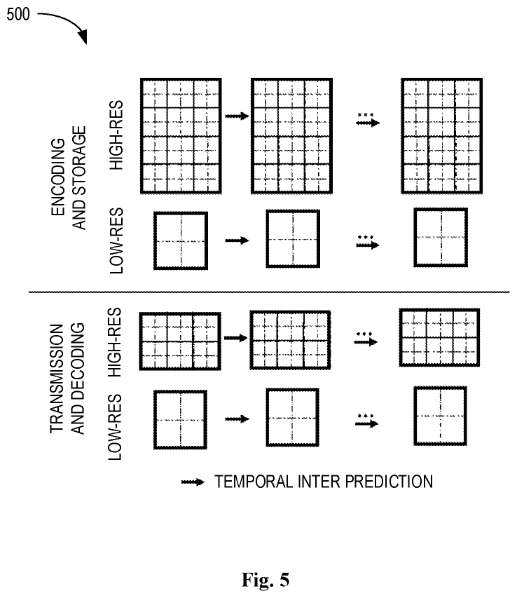

FIG. 5 illustrates a schematic diagram 500 of a typical subpicture-based viewport-dependent 360° video delivery scheme. Another typical subpicture-based viewport-dependent 360° video delivery scheme is shown in FIG. 5, wherein only a higher-resolution representation of the full video consists of subpictures, while a lower-resolution representation of the full video does not use subpictures and can be coded with less frequent RAPs than the higher-resolution representation. The client receives the full video in the lower-resolution while for the higher-resolution video, the client only receives and decodes the subpictures that cover the current viewport.

### 2.4.2. Differences Between Subpictures and MCTSs

There are several important design differences between subpictures and MCTSs. First, the subpictures feature in VVC allows motion vectors of a coding block pointing outside of the subpicture even when the subpicture is extractable by applying sample padding at subpicture boundaries in this case, similarly as at picture boundaries. Second, additional changes were introduced for the selection and derivation of motion vectors in the merge mode and in the decoder side motion vector refinement process of VVC. This allows higher coding efficiency compared to the non-normative motion constraints applied at encoder-side for MCTSs. Third, rewriting of SHs (and PH NAL units, when present) is not needed when extracting of one or more extractable subpictures from a sequence of pictures to create a sub-bitstream that is a conforming bitstream. In sub-bitstream extractions based on HEVC MCTSs, rewriting of SHs is needed. Note that in both HEVC MCTSs extraction and VVC subpictures extraction, rewriting of SPSs and PPSs is needed. However, typically there are only a few parameter sets in a bitstream, while each picture has at least one slice, therefore rewriting of SHs can be a significant burden for application systems. Fourth, slices of different subpictures within a picture are allowed to have different NAL unit types. This is the feature often referred to as mixed NAL unit types or mixed subpicture types within a picture, discussed in more detail below. Fifth, VVC specifies HRD and level definitions for subpicture sequences, thus the conformance of the sub-bitstream of each extractable subpicture sequence can be ensured by encoders.

2.4.3. Mixed Subpicture Types within a Picture

In AVC and HEVC, all VCL NAL units in a picture need to have the same NAL unit type. VVC introduces the option to mix subpictures with certain different VCL NAL unit types within a picture, thus providing support for random access not only at the picture level but also at the subpicture level. In VVC VCL NAL units within a subpicture are still required to have the same NAL unit type.

The capability of random accessing from IRAP subpictures is beneficial for 360° video applications. In viewport-dependent 360° video delivery schemes similar to the one shown in FIG. 5, the content of spatially neighboring viewports largely overlaps, i.e. only a fraction of subpictures in a viewport is replaced by new subpictures during a viewport orientation change, while most subpictures remain in the viewport. Subpicture sequences that are newly introduced into the viewport must begin with IRAP slices but significant reduction in overall transmission bit rate can be achieved when the remaining subpictures are allowed to carry out inter-prediction at viewport changes.

The indication of whether a picture contains just a single type of NAL units or more than one type is provided in the PPS referred to by the picture (i.e., using a flag called pps_mixed_nalu_types_in_pic_flag). A picture may consist of subpictures containing IRAP slices and subpictures containing trailing slices at the same time. A few other combinations of different NAL unit types within a picture are also allowed, including leading picture slices of NAL unit types RASL and RADL, which allows the merging of subpicture sequences with open-GOP and close-GOP coding structures extracted from different bitstreams into one bitstream.

### 2.4.4. Subpicture Layout and ID Signaling

The layout of subpictures in VVC is signaled in the SPS, thus constant within a CLVS. Each subpicture is signaled by the position of its top-left CTU and its width and height in number of CTUs, therefore ensuring that a subpicture covers a rectangular region of the picture with CTU granularity. The order in which the subpictures are signaled in the SPS determines the index of each subpicture within the picture.

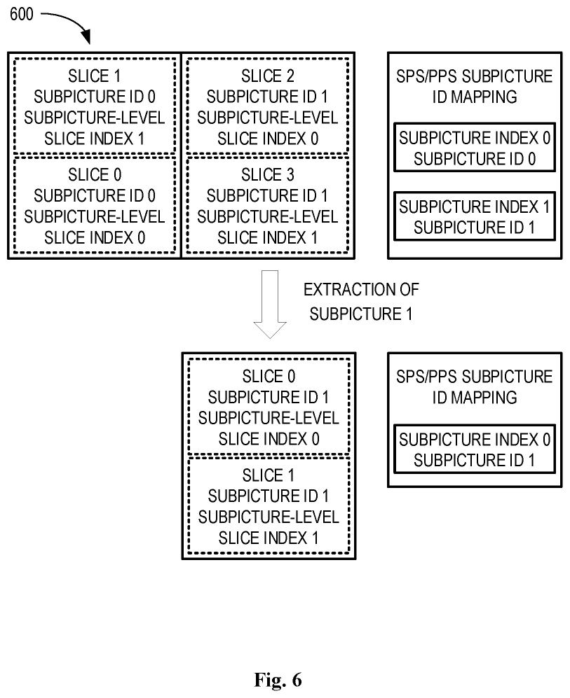

For enabling extraction and merging of subpicture sequences without rewriting of SHs or PHs, the slice addressing scheme in VVC is based on subpicture IDs and a subpicture-specific slice index to associate slices to subpictures. In the SH, the subpicture ID of the subpicture containing the slice and the subpicture-level slice index are signaled. Note that the value of subpicture ID of a particular subpicture can be different from the value of its subpicture index. A mapping between the two is either signaled in the SPS or PPS (but never both) or implicitly inferred. When present, the subpicture ID mapping needs to be rewritten or added when rewriting the SPSs and PPSs during the subpicture sub-bitstream extraction process. The subpicture ID and the subpicture-level slice index together indicate to the decoder the exact position of the first decoded CTU of a slice within the DPB slot of the decoded picture. After sub-bitstream extraction, the subpicture ID of a subpicture remains unchanged while the subpicture index may change. Even when the raster-scan CTU address of the first CTU in a slice in the subpicture has changed compared to the value in the original bitstream, the unchanged values of subpicture ID and subpicture-level slice index in the respective SH would still correctly determine the position of each CTU in the decoded picture of the extracted sub-bitstream. FIG. 6 illustrates a schematic diagram 600 of the usage of subpicture ID, subpicture index and subpicture-level slice index to enable subpicture extraction with an example containing two subpictures and four slices.

Similar to subpicture extraction, the signaling for subpictures allows merging several subpictures from different bitstreams into a single bitstream by only rewriting the SPSs and PPSs, provided that the different bitstreams are coordinately generated (e.g., using distinct subpicture IDs but otherwise mostly aligned SPS, PPS and PH parameters such as CTU size, chroma format, coding tools, etc.).

While subpictures and slices are independently signaled in the SPS and PPS, respectively, there are inherent reciprocal constraints between the subpicture and slice layouts in order to form a conformant bitstream. First, the presence of subpictures requires using rectangular slices and forbids raster-scan slices. Second, the slices of a given subpicture shall be consecutive NAL units in decoding order, which means that the subpicture layout constrains the order of coded slice NAL units within the bitstream.

### 2.5. Picture-In-Picture Services

Picture-in-picture services offer the ability to include a picture with a small resolution within a picture with a bigger resolution. Such a service may be beneficial to show two videos to a user at the same time, whereby the video with bigger resolution is considered as the main video and the video with a smaller resolution is considered as the supplementary video. Such a picture-in-picture service can be used to offer accessibility services where the main video is supplemented by a signage video.

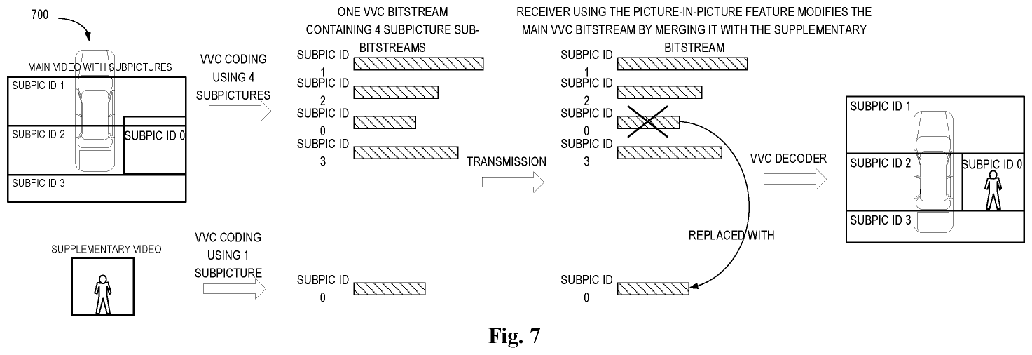

VVC subpictures can be used for picture-in-picture services by using both the extraction and merging properties of VVC subpictures. For such a service, the main video is encoded using a number of subpictures, one of them of the same size as a supplementary video, located at the exact location where the supplementary video is intended to be composited into the main video and coded independently to enable extraction. FIG. 7 illustrates a schematic diagram 700 of extraction of one subpicture from a bitstream containing two subpictures and four slices. If a user chooses to view the version of the service that includes the supplementary video, the subpicture that corresponds to the picture-in-picture area of the main video is extracted from the main video bitstream, and the supplementary video bitstream is merged with the main video bitstream in its place, as illustrated in FIG. 7.

In this case, the pictures of the main and the supplementary video have to share the same video characteristics, in particular bit depth, sample aspect ratio, size, frame rate, colour space and transfer characteristics, chroma samples location, must be the same. Main and supplementary video bitstreams do not need to use the NAL unit types within each picture. However, merging requires the coding order of the pictures in main and supplementary bitstreams to be the same.

Since merging of subpictures is required herein, the subpicture IDs used within the main video and the supplementary video cannot overlap. Even if the supplementary video bitstream is composed of only one subpicture without any further tiles or slice partitioning, subpicture information, in particular subpicture ID and subpicture ID length need to be signalled to enable merging of the supplementary video bitstream with the main video bitstream. The subpicture ID length used to signal the length of the subpicture ID syntax element within the slice NAL units of the supplementary video bitstream has to be the same as the subpicture ID length used to signal the subpicture IDs within the slice NAL units of the main video bitstream. In addition, in order to simplify merging of the supplementary video bitstream with the main video bitstream without the need to rewrite the PPS partitioning information, it may be beneficial to use only one slice and one tile for encoding the supplementary video and within the corresponding area of the main video. The main and supplementary video bitstreams have to signal the same coding tools in SPS, PPS and picture headers. It includes using the same maximum and minimum allowed sizes for block partitioning, and the same value of initial Quantization Parameter as signalled in the PPS (same value of the pps_init_qp_minus26 syntax element). Coding tools usage can be modified at the slice header level.

When both main and supplementary bitstreams are available via a DASH-based delivery system, DASH Preselections may be used to signal main and supplementary bitstreams that are intended to be merged and rendered together.

### 3. Problems

The following issues have been observed for support of picture-in-picture services in DASH:
1) While it is possible to use a DASH Preselection for the picture-in-picture experience, there lacks an indication of such a purpose.
2) While it is possible to use VVC subpictures for the picture-in-picture experience e.g., as discussed above, it is also possible to use other codecs and methods without being able to replace the coded video data units representing the target picture-in-picture region in the main video with the corresponding video data units of the supplementary video. Therefore, there is a need to indicate whether such replacement is possible.
3) When the above replacement is possible, the client needs to know which coded video data units in each picture of the main video represent the target picture-in-picture region, to be able to perform the replacement. Therefore, this information needs to be signalled.
4) For content selection purpose and possibly other purposes as well, it would be useful to signal the position and size of the target picture-in-picture region in the main video.

### 4. Embodiments of the Present Disclosure

To solve the above-described problem, methods as summarized below are disclosed. Embodiments should be considered as examples to explain the general concepts and should not be interpreted in a narrow way. Furthermore, these embodiments can be applied individually or combined in any manner.
1) To solve the first problem, a new descriptor, e.g., named the picture-in-picture descriptor is defined, and the presence of this descriptor in a Preselection indicates that the purpose of the Preselection is for providing a picture-in-picture experience.
   a. In one example, this new descriptor is a defined as a supplemental descriptor, through extending the SupplementalProperty element.
   b. In one example, this new descriptor is identified by a value of the @schemeIdUri attribute equal to “urn:mpeg:dash:pinp:2021” or a similar URN string.
2) To solve the second problem, in the new picture-in-picture descriptor, signal an indication of whether the coded video data units representing the target picture-in-picture region in the main video can be replaced by the corresponding video data units of the supplementary video.
   a. In one example, this indication is signalled by an attribute, e.g., named @dataUnitsReplacable, of an element in the new picture-in-picture descriptor.
3) To solve the third problem, in the new picture-in-picture descriptor, a list of region IDs is signalled, for indicating which coded video data units in each picture of the main video represent the target picture-in-picture region.
   a. In one example, the list of region IDs is signalled as an attribute of an element in the new picture-in-picture descriptor, e.g., named @regionIds.
4) To solve the third problem, in the new picture-in-picture descriptor, signal the information on the position and size in the main video for embedding/overlaying the supplementary video, which is smaller in size than the main video.
   a. In one example, this is signalled by signal the four values (x, y, width, height), with x, y specifying the location of the top left corner of the region, and the width and height specifying the width and height of the region. The units can be in luma samples/pixels.
   b. In one example, this is signalled by a number of attributes of an element in the new picture-in-picture descriptor.

### 5. Embodiments

Below are some example embodiments for some of the present disclosure items and their subitems summarized above in Section 4.

### 5.1. Embodiment 1

This embodiment is for all the present disclosure items and their subitems summarized above in Section 4.

### 5.1.1. DASH Picture-In-Picture Descriptor

A SupplementalProperty element with a @schemeIdUri attribute equal to “urn:mpeg:dash:pinp:2021” is referred to as a picture-in-picture descriptor.

At most one picture-in-picture descriptor may be present at Preselection level. The presence of a picture-in-picture descriptor in a Preselection indicates that that the purpose of the Preselection is for providing a picture-in-picture experience.

Picture-in-picture services offer the ability to include a video with a smaller spatial resolution within a video with a bigger spatial resolution. In this case, the different bitstreams/Representations of the main video are included in the Main Adaptation Set of the Preselection, and the different bitstreams/Representations of a supplementary video are included a Partial Adaptation Set of the Preselection.

When a picture-in-picture descriptor is present in a Preselection, and the picInPicInfo@dataUnitsReplacable attribute is present and equal to true, the client may choose to replace the coded video data units representing the target picture-in-picture region in the main video with the corresponding coded video data units of the supplementary video before sending to the video decoder. This way, separate decoding of the main video and the supplementary video can be avoided. For a particular picture in the main video, the corresponding video data units of the supplementary video are all the coded video data units in the decoding-time-synchronized sample in the supplemental video Representation.

In the case of VVC, when the client chooses to replace the coded video data units (which are VCL NAL units) representing the target picture-in-picture region in the main video with the corresponding VCL NAL units of the supplementary video before sending to the video decoder, for each subpicture ID, the VCL NAL units in the main video are replaced with the corresponding VCL NAL units having that subpicture ID in the supplementary video, without changing the order of the corresponding VCL NAL units.

The @value attribute of the picture-in-picture descriptor shall not be present. The picture-in-picture descriptor shall include a picInPicInfo element with its attributes as specified in the following table:

TABLE 1
Semantics of picInPicInfo element

| Element or Attribute Name | Use | Description |
|---|---|---|
| PicInpicInfo | | |
| @dataUnitsReplacable | OD | specifies whether the coded video data units |
| | Default: | representing the target picture-in-picture |
| | ‘false’ | region in the main video can be replaced by |
| | | the corresponding video data units of the |
| | | supplementary video. |
| | | When @dataUnitsReplacable is equal to ‘true’, |
| | | the client may choose to replace the coded |
| | | video data units representing the target |
| | | picture-in-picture region in the main video |
| | | with the corresponding coded video data units |
| | | of the supplementary video before sending to |
| | | the video decoder for decoding. |
| @regionIds | O | specifies the IDs of the coded video data units |
| | | representing the target picture-in-picture |
| | | region, as a white space separated list. |
| | | The concrete semantics of the region IDs need |
| | | to be explicitly specified for specific video |
| | | codecs. |
| | | In the case of VVC, the region IDs are |
| | | subpicture IDs, and coded video data units are |
| | | VCL NAL units. The VCL NAL units |
| | | representing the target picture-in-picture |
| | | region in the main video are those having |
| | | these subpicture IDs, which are the same as |
| | | the subpicture IDs in the corresponding VCL |
| | | NAL units of the supplementary video. |
| @x | C | specifies the horizontal position of the top-left |
| | | encoded video pixel (sample) of the target |
| | | picture-in-picture region in the main video. |
| | | The unit is video pixels (samples). The four |
| | | attributes @x, @y, @width, and @height shall |
| | | be either all present or all absent. |
| @y | O | specifies the vertical position of the top-left |
| | | encoded video pixel (sample) of the target |
| | | picture-in-picture region in the main video. |
| | | The unit is video pixels (samples). |
| @width | O | specifies the width the target picture-in-picture |
| | | region in the main video. The unit is video |
| | | pixels (samples). |
| @height | O | specifies the height the target picture-in- |
| | | picture region in the main video. The unit is |
| | | video pixels (samples). |

Key
For attributes:
M = mandatory,
O = Optional,
OD = optional with default value,
CM = conditionally mandatory
For elements:
<minOccurs>..<maxOccurs> (N = unbounded)
Elements are bold;
attributes are non-bold and preceded with an @.

### 5.3.11.6.3 XML Syntax of the PicInpicInfo Element

```
<xs:complexType name=“PicInpicInfoType”>
  <xs:annotation>
    <xs:documentation xml:lang=“en”>
    Picnpic
  </xs:documentation>
  </xs:annotation>
  <xs:attribute name=“dataUnitReplacable” type=“xs:boolean”
  default=“false” />
  <xs:attribute name=“regionIds” type=“StringNoWhitespaceType”/>
  <xs:attribute name=“x” type=“xs:unsignedInt” />
  <xs:attribute name=“y” type=“xs:unsignedInt” />
  <xs:attribute name=“width” type=“xs:unsignedInt” />
  <xs:attribute name=“height” type=“xs:unsignedInt” />
  <xs:anyAttribute namespace=“##other” processContents=“lax”/>
  </xs:complexType>
```

FIG. 8 illustrates a flowchart of a method 800 for video processing in accordance with some embodiments of the present disclosure. The method 800 may be implemented at a first device. For example, the method 800 may be implanted at a client or a receiver. The term “client” used herein may refer to a piece of computer hardware or software that accesses a service made available by a server as part of the client-server model of computer networks. Only as an example, the client may be a smartphone or a tablet. In some embodiments, the first device may be implemented at the destination device 120 shown in FIG. 1.

At block 810, the first device receives a metadata file from a second device. The metadata file may comprise important information about video bitstreams, e.g., the profile, tier, and level, and the like. For example, the metadata file may be a DASH media presentation description (MPD) for content selection purposes, e.g., for selection of appropriate media segments both for initialization at the beginning of a streaming session and for stream adaptation during the streaming session.

At block 820, the first device determines a list of region identities (IDs) for indicating a first set of coded video data units in each picture of the first video representing a target picture-in-picture region from the metadata file. In some embodiments, the list of region IDs may be an attribute of an element in a descriptor in the metadata file. For example, the attribute may be a regionIds. In some embodiments, a region ID in the list of region IDs may be a subpicture ID. The target picture-in-picture region may be able to be replaced by a second set of coded video units in the second video. In some embodiments, the first set of coded video data units may comprise a first set of video coding layer network abstraction layer (VCL NAL) units, and the second set of coded video data units may comprise a second set of VCL NAL units. In this way, the first device knows which coded video data units in each picture of the first video represent the target picture-in-picture region and can perform the replacement.

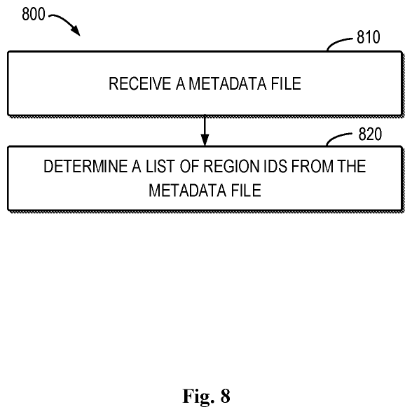

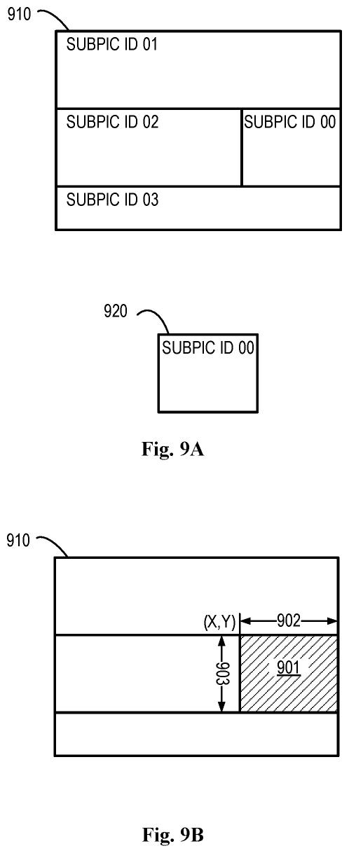

In some embodiments, the list of region ID may allow the first set of coded video data units replaced by the second set of coded video units. For example, for one region ID in the list of region IDs, the first device may replace the first set of coded video data units having the region ID in the first video with the second set of coded video units having the region ID in the second video. As shown in FIG. 9A, the first video may comprise the subpictures with subpicture (subpic) IDs 00, 01, 02 and 03. For example, if the list of region IDs in the metadata file comprises the subpicture ID 00, the set of coded video data units having the subpicture ID 00 in the first video 910 may be replaced with the second of coded video units having the subpicture 00 in the second video 920.

By way of example, in the case of VVC, when the first device chooses to replace the coded video data units (which are VCL NAL units) representing the target picture-in-picture region in the main video with the corresponding VCL NAL units of the supplementary video before sending to the video decoder, for each subpicture ID, the VCL NAL units in the main video may be replaced with the corresponding VCL NAL units having that subpicture ID in the supplementary video, without changing the order of the corresponding VCL NAL units. For example, Table 2 below shows an example of a picture-in-picture element with its attributes in the descriptor. It should be noted that Table 2 is only an example not limitation.

TABLE 2

| Element or Attribute Name | Use | Description |
|---|---|---|
| PicInpicInfo | | |
| @regionIds | O | specifies the IDs of the coded video |
| | | data units representing the target |
| | | picture-in-picture region, as a white |
| | | space separated list. |
| | | The concrete semantics of the |
| | | region IDs need to be explicitly |
| | | specified for specific video codecs. |
| | | In the case of VVC, the region IDs |
| | | are subpicture IDs, and coded video |
| | | data units are VCL NAL units. The |
| | | VCL NAL units representing the |
| | | target picture-in-picture region in |
| | | the main video are those having |
| | | these subpicture IDs, which are the |
| | | same as the subpicture IDs in the |
| | | corresponding VCL NAL units of |
| | | the supplementary video. |

In some embodiments, the first device may determine, from the metadata file, an indication for indicating whether a first set of coded video data units representing a target picture-in-picture region in a first video is replaceable by a second set of coded video data units in a second video may be determined from the metadata file. In some embodiments, the indication may be an attribute of an element in a descriptor (for example, the picture-in-picture descriptor) in the metadata file. For example, the attribute may be dataUnitsReplacable. In this way, separate decoding of the main video and the supplementary video can be avoided. In addition, it can also save transmission resources for transmitting the main video and the supplementary video.

In some examples, the indication may allow the first set of coded video data units replaced by the second set of coded video data units. For example, if the indication indicates the first set of coded video data units representing the target picture-in-picture region in the first video is able to be replaced by the second set of coded video data units in the second video, the first set of coded video data units may be replaced with the second set of coded video data units. In this case, the main video which comprises the second set of coded video data units from the supplementary video may be decoded. By way of example, when the descriptor (i.e., the picture-in-picture descriptor) is present in a Preselection, and the picInPicInfo@dataUnitsReplacable attribute may be present and equal to true, the first device may choose to replace the coded video data units representing the target picture-in-picture region in the main video with the corresponding coded video data units of the supplementary video before sending to the video decoder. For a particular picture in the main video, the corresponding video data units of the supplementary video may be all the coded video data units in the decoding-time-synchronized sample in the supplemental video Representation. For example, Table 3 below shows an example of a picture-in-picture element with its attributes in the descriptor. It should be noted that Table 3 is only an example not limitation.

TABLE 3

| Element or Attribute Name | Use | Description |
|---|---|---|
| PicInpicInfo | | |
| @dataUnitsReplacable | OD | specifies whether the coded video data units |
| | Default: | representing the target picture-in-picture |
| | ‘false’ | region in the main video can be replaced by |
| | | the corresponding video data units of the |
| | | supplementary video. |
| | | When @dataUnitsReplacable is equal to ‘true’, |
| | | the client may choose to replace the coded |
| | | video data units representing the target |
| | | picture-in-picture region in the main video |
| | | with the corresponding coded video data units |
| | | of the supplementary video before sending to |
| | | the video decoder for decoding. |

In some embodiments, the metadata file may comprise a descriptor (i.e., the picture-in-picture descriptor). In this case, a presence of the descriptor indicates that the data structure is for providing a picture-in-picture service. In other words, if the data structure comprises the descriptor, it means that the data structure is for providing the picture-in-picture service. The picture-in-picture service may offer the ability to include a video with a smaller spatial resolution within a video with a bigger spatial resolution. In this way, it can indicate to use a DASH Preselection for the picture-in-picture experience.

The data structure may indicate a selection of a first set of bitstreams of the first video and a second set of bitstreams of the second video for the picture-in-picture service. The first video may also be referred to as “main video” and the second video may also be referred to as “supplementary video.” The picture-in-picture service may offer the ability to include a video with a smaller spatial resolution (i.e., the second video or the supplementary video) within a video with a bigger spatial resolution (i.e., the first video or the main video). In some embodiments, the data structure may be a Preselection of the metadata file. In other words, the descriptor may be present at Preselection level. A preselection may define an audio and/or video experience created by one or multiple audio and/or video components that are decoded and rendered simultaneously. By way of example, in some embodiments, at most one descriptor may be present at Preselection level. In some embodiments, the metadata file may comprise one or more Preselections. In some embodiments, a main adaptation of the data structure may comprise the first set of bitstreams of the first video, and a partial adaptation set of the data structure may comprise the second set of bitstreams of the supplementary video. For example, as mentioned above, a picture-in-picture service may offer the ability to include a video with a smaller spatial resolution (i.e., the second video/supplementary video) within a video with a bigger spatial resolution (i.e., the first video/main video). In this case, the different bitstreams/representations of the first video may be included in the Main Adaptation Set of the Preselection, and the different bitstreams/representations of the second video may be included a Partial Adaptation Set of the Preselection.

In some embodiments, the descriptor may be defined as a supplemental descriptor based on a SupplementalProperty element in the metadata file. In some embodiments, the descriptor may be identified by a value of an attribute equal to a uniform resource name (URN) string. For example, the attribute is a schemeIdUri attribute. In some example embodiments, the UR string may be “urn:mpeg:dash:pinp:2022”. The UR string may be any suitable value, for example, the UR string may be “urn:mpeg:dash:pinp:2021” or “urn:mpeg:dash:pinp:2023”. By way of example, a SupplementalProperty element with a @schemeIdUri attribute equal to “urn:mpeg:dash:pinp:2022” may be referred to as the descriptor, i.e., the picture-in-picture descriptor.

In some embodiments, the descriptor may indicate position information and size information of a region in the first video for embedding or overlaying the second video. In this case, the region may be smaller in size than the first video. In some embodiments, the region may comprise luma samples or luma pixels. In this way, the content can be properly selected based on the position information and size information of the region.

In some embodiments, the position information may indicate a horizontal position of a top-left corner of the region and a vertical position of the top-left corner of the region. Alternatively, or in addition, the size information may indicate a width of the region and a height of the region. In one example, this is signalled by signal the four values (x, y, width, height), with x, y specifying the location of the top left corner of the region, and the width and height specifying the width and height of the region. For example, as shown in FIG. 9B, the position information may indicate the horizontal position X and the vertical position Y of the picture-in-picture region 901 in the first video 910. The size information may also comprise the width 902 and the height 903 of the picture-in-picture region 901.

In some embodiments, a set of attributes of an element in the descriptor may indicate the position information and the size information of the region. For example, Table 4 below shows an example of a picture-in-picture element with its attributes in the descriptor. It should be noted that Table 4 is only an example not limitation.

TABLE 4

| Element or Attribute Name | Use | Description |
|---|---|---|
| PicInpicInfo | | |
| @x | O | specifies the horizontal position of the top-left |
| | | encoded video pixel (sample) of the target |
| | | picture-in-picture region in the main video. |
| | | The unit is video pixels (samples). The four |
| | | attributes @x, @y, @width, and @height shall |
| | | be either all present or all absent. |
| @y | O | specifies the vertical position of the top-left |
| | | encoded video pixel (sample) of the target |
| | | picture-in-picture region in the main video. |
| | | The unit is video pixels (samples). |
| @width | O | specifies the width the target picture-in-picture |
| | | region in the main video. The unit is video |
| | | pixels (samples). |
| @height | O | specifies the height the target picture-in- |
| | | picture region in the main video. The unit is |
| | | video pixels (samples). |

Key
For attributes:
M = mandatory,
O = Optional,
OD = optional with default value,
CM = conditionally mandatory
For elements:
<minOccurs>..<maxOccurs> (N = unbounded)
Elements are bold;
attributes are non-bold and preceded with an @.

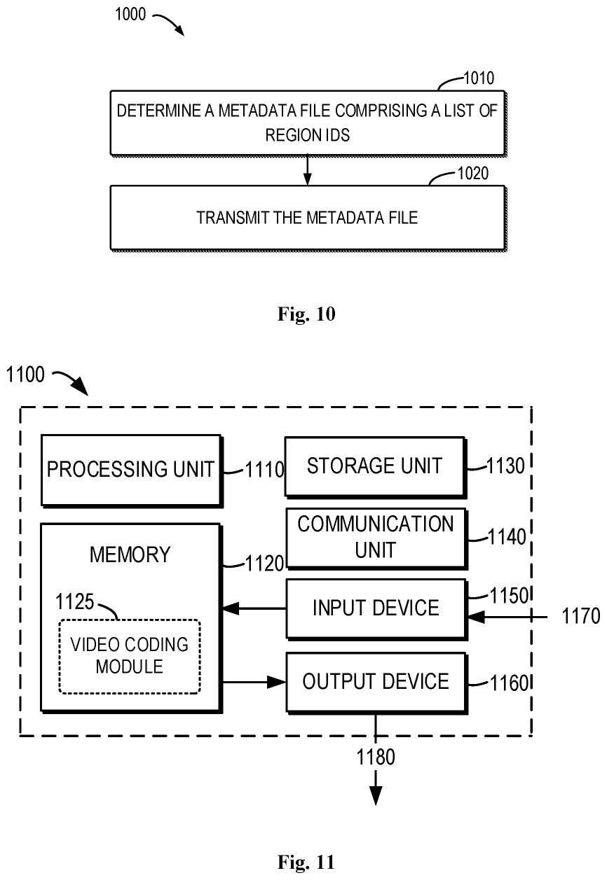

FIG. 10 illustrates a flowchart of a method 1000 for video processing in accordance with some embodiments of the present disclosure. The method 1000 may be implemented at a second device. For example, the method 1000 may be implanted at a server or a sender. The term “server” used herein may refer to a device capable of computing, in which case the client accesses the service by way of a network. The server may be a physical computing device or a virtual computing device. In some embodiments, the second device may be implemented at the source device 110 shown in FIG. 1.

At block 1010, the second device determines a metadata file. The metadata file comprises a list of region identities (IDs) for indicating a first set of coded video data units in each picture of the first video representing a target picture-in-picture region. The target picture-in-picture region is replaceable by a second set of coded video units in a second video.

In some embodiments, the list of region IDs may be an attribute of an element in a descriptor in the metadata file. For example, the attribute may be a regionIds. In some embodiments, a region ID in the list of region IDs may be a subpicture ID. The target picture-in-picture region may be able to be replaced by a second set of coded video units in the second video. In some embodiments, the first set of coded video data units may comprise a first set of video coding layer network abstraction layer (VCL NAL) units, and the second set of coded video data units may comprise a second set of VCL NAL units.

At block 1020, the second device transmits the metadata file to the first device. In this way, the first device knows which coded video data units in each picture of the first video represent the target picture-in-picture region and can perform the replacement.

In some embodiments, the metadata file may also comprise an indication for indicating whether a first set of coded video data units representing a target picture-in-picture region in a first video is replaceable by a second set of coded video data units in a second video may be determined from the metadata file. In some embodiments, the indication may be an attribute of an element in a descriptor (for example, the picture-in-picture descriptor) in the metadata file. For example, the attribute may be dataUnitsReplacable. In this way, separate decoding of the main video and the supplementary video can be avoided. In addition, it can also save transmission resources for transmitting the main video and the supplementary video.

In some examples, if the indication indicates the first set of coded video data units representing the target picture-in-picture region in the first video is replaceable by the second set of coded video data units in the second video, the first set of coded video data units may be replaced with the second set of coded video data units. In this case, the main video which comprises the second set of coded video data units from the supplementary video may be decoded. By way of example, when the descriptor (i.e., the picture-in-picture descriptor) is present in a Preselection, and the picInPicInfo@dataUnitsReplacable attribute may be present and equal to true, the first device may choose to replace the coded video data units representing the target picture-in-picture region in the main video with the corresponding coded video data units of the supplementary video before sending to the video decoder. For a particular picture in the main video, the corresponding video data units of the supplementary video may be all the coded video data units in the decoding-time-synchronized sample in the supplemental video Representation.

The metadata file may comprise important information about video bitstreams, e.g., the profile, tier, and level, and the like. For example, the metadata file may be a DASH media presentation description (MPD) for content selection purposes, e.g., for selection of appropriate media segments both for initialization at the beginning of a streaming session and for stream adaptation during the streaming session.

In some embodiments, the metadata file may comprise a descriptor, for example, the picture-in-picture descriptor. In this case, a presence of the descriptor may indicate that the data structure is for providing a picture-in-picture service. In other words, if the data structure comprises the descriptor, it means that the data structure is for providing the picture-in-picture service. The picture-in-picture service may offer the ability to include a video with a smaller spatial resolution within a video with a bigger spatial resolution.

In some embodiments, the descriptor may be defined as a supplemental descriptor based on a SupplementalProperty element in the metadata file. In some embodiments, the descriptor may be identified by a value of an attribute equal to a uniform resource name (URN) string. For example, the attribute is a schemeIdUri attribute. In some example embodiments, the UR string may be “urn:mpeg:dash:pinp:2022”. The UR string may be any suitable value, for example, the UR string may be “urn:mpeg:dash:pinp:2021” or “urn:mpeg:dash:pinp:2023”. By way of example, a SupplementalProperty element with a @schemeIdUri attribute equal to “urn:mpeg:dash:pinp:2022” may be referred to as the descriptor, i.e., the picture-in-picture descriptor.

In some embodiments, a data structure may indicate a selection of a first set of bitstreams of a first video and a second set of bitstreams of a second video for the picture-in-picture service. In some embodiments, the data structure may be a Preselection of the metadata file. In other words, the descriptor may be present at Preselection level. A preselection may define an audio and/or video experience created by one or multiple audio and/or video components that are decoded and rendered simultaneously. By way of example, in some embodiments, at most one descriptor may be present at Preselection level. In some embodiments, the metadata file may comprise one or more Preselections.

In some embodiments, a main adaptation of the data structure may comprise the first set of bitstreams of the first video, and a partial adaptation set of the data structure may comprise the second set of bitstreams of the second video. For example, as mentioned above, a picture-in-picture service may offer the ability to include a video with a smaller spatial resolution (i.e., the second video or the supplementary video) within a video with a bigger spatial resolution (i.e., the first video or the main video). In this case, the different bitstreams/representations of the first video may be included in the Main Adaptation Set of the Preselection, and the different bitstreams/representations of the second video may be included a Partial Adaptation Set of the Preselection.

In some embodiments, the descriptor may indicate position information and size information of a region in the first video for embedding or overlaying the second video. In this case, the region may be smaller in size than the first video. In some embodiments, the region may comprise luma samples or luma pixels. In this way, the content can be properly selected based on the position information and size information of the region.

In some embodiments, the position information may indicate a horizontal position of a top-left corner of the region and a vertical position of the top-left corner of the region. Alternatively, or in addition, the size information may indicate a width of the region and a height of the region. In one example, this is signalled by signal the four values (x, y, width, height), with x, y specifying the location of the top left corner of the region, and the width and height specifying the width and height of the region. In some embodiments, a set of attributes of an element in the descriptor may indicate the position information and the size information of the region.

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.

Clause 1. A method of video processing, comprising: receiving, by a first device, a metadata file from a server; and determining, from the metadata file, a list of region identities (IDs) for indicating a first set of coded video data units in each picture of a first video representing a target picture-in-picture region which is replaceable by a second set of coded video units in a second video.

Clause 2. The method of clause 1, wherein the list of region IDs is an attribute of an element in a descriptor in the metadata file.

Clause 3. The method of clause 2, wherein the attribute is a regionIds.

Clause 4. The method of any of clauses 1-3, wherein one region ID in the list of region IDs allows the first set of coded video data units having the region ID in the first video replaced with the second set of coded video unit having the region ID in the second video before decoding the first video.

Clause 5. The method of any of clauses 1-4, wherein a region ID in the list of region IDs is a subpicture ID, the first set of coded video data units comprise a first set of video coding layer network abstraction layer (VCL NAL) units, and the second set of coded video data units comprise a second set of VCL NAL units.

Clause 6. A method of video processing, comprising: determining, at a second device, a metadata file, the metadata file comprising a list of region identities (IDs) for indicating a first set of coded video data units in each picture of a main video representing a target picture-in-picture region which is able to be replaced by a second set of coded video units in a supplementary video; and transmitting the metadata file to a first device.

Clause 7. The method of clause 6, wherein the list of region IDs is an attribute of an element in a descriptor in the metadata file.

Clause 8. The method of clause 8, wherein the attribute is a regionIds.

Clause 9. The method of any of clauses 6-8, wherein one region ID in the list of region IDs allows the first set of coded video data units having the region ID in the first video replaced with the second set of coded video unit having the region ID in the second video before decoding the first video.

Clause 10. The method of any of clauses 6-9, wherein a region ID in the list of region IDs is a subpicture ID, the first set of coded video data units comprise a first set of video coding layer network abstraction layer (VCL NAL) units, and the second set of coded video data units comprise a second set of VCL NAL units.

Clause 11. An apparatus for processing video data comprising a processor and a non-transitory memory with instructions thereon, wherein the instructions upon execution by the processor, cause the processor to perform a method in accordance with any of Clauses 1-10.

Clause 12. A non-transitory computer-readable storage medium storing instructions that cause a processor to perform a method in accordance with any of Clauses 1-10.

### Example Device

FIG. 11 illustrates a block diagram of a computing device 1100 in which various embodiments of the present disclosure can be implemented. The computing device 1100 may be implemented as or included in the source device 110 (or the video encoder 114 or 200) or the destination device 120 (or the video decoder 124 or 300).

It would be appreciated that the computing device 1100 shown in FIG. 11 is merely for purpose of illustration, without suggesting any limitation to the functions and scopes of the embodiments of the present disclosure in any manner.

As shown in FIG. 11, the computing device 1100 includes a general-purpose computing device 1100. The computing device 1100 may at least comprise one or more processors or processing units 1110, a memory 1120, a storage unit 1130, one or more communication units 1140, one or more input devices 1150, and one or more output devices 1160.

In some embodiments, the computing device 1100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1100 can support any type of interface to a user (such as “wearable” circuitry and the like).

The processing unit 1110 may be a physical or virtual processor and can implement various processes based on programs stored in the memory 1120. In a multi-processor system, multiple processing units execute computer executable instructions in parallel so as to improve the parallel processing capability of the computing device 1100. The processing unit 1110 may also be referred to as a central processing unit (CPU), a microprocessor, a controller or a microcontroller.

The computing device 1100 typically includes various computer storage medium. Such medium can be any medium accessible by the computing device 1100, including, but not limited to, volatile and non-volatile medium, or detachable and non-detachable medium. The memory 1120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1130 may be any detachable or non-detachable medium and may include a machine-readable medium such as a memory, flash memory drive, magnetic disk or another other media, which can be used for storing information and/or data and can be accessed in the computing device 1100.

The computing device 1100 may further include additional detachable/non-detachable, volatile/non-volatile memory medium. Although not shown in FIG. 11, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1140 communicates with a further computing device via the communication medium. In addition, the functions of the components in the computing device 1100 can be implemented by a single computing cluster or multiple computing machines that can communicate via communication connections. Therefore, the computing device 1100 can operate in a networked environment using a logical connection with one or more other servers, networked personal computers (PCs) or further general network nodes.

The input device 1150 may be one or more of a variety of input devices, such as a mouse, keyboard, tracking ball, voice-input device, and the like. The output device 1160 may be one or more of a variety of output devices, such as a display, loudspeaker, printer, and the like. By means of the communication unit 1140, the computing device 1100 can further communicate with one or more external devices (not shown) such as the storage devices and display device, with one or more devices enabling the user to interact with the computing device 1100, or any devices (such as a network card, a modem and the like) enabling the computing device 1100 to communicate with one or more other computing devices, if required. Such communication can be performed via input/output (I/O) interfaces (not shown).

In some embodiments, instead of being integrated in a single device, some or all components of the computing device 1100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1100 may be used to implement video encoding/decoding in embodiments of the present disclosure. The memory 1120 may include one or more video coding modules 1125 having one or more program instructions. These modules are accessible and executable by the processing unit 1110 to perform the functionalities of the various embodiments described herein.

In the example embodiments of performing video encoding, the input device 1150 may receive video data as an input 1170 to be encoded. The video data may be processed, for example, by the video coding module 1125, to generate an encoded bitstream. The encoded bitstream may be provided via the output device 1160 as an output 1180.

In the example embodiments of performing video decoding, the input device 1150 may receive an encoded bitstream as the input 1170. The encoded bitstream may be processed, for example, by the video coding module 1125, to generate decoded video data. The decoded video data may be provided via the output device 1160 as the output 1180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
receiving, by a first device, a metadata file from a server; and
determining, from the metadata file, a list of region identities (IDs) for indicating a first set of coded video data units in each picture of a first video representing a target picture-in-picture region which is replaceable by a second set of coded video units in a second video.

2. The method of claim 1, wherein the list of region IDs is an attribute of an element in a descriptor in the metadata file.

3. The method of claim 2, wherein the attribute is a regionIds.

4. The method of claim 1, wherein one region ID in the list of region IDs allows the first set of coded video data units having the region ID in the first video replaced with the second set of coded video unit having the region ID in the second video before decoding the first video.

5. The method of claim 1, wherein a region ID in the list of region IDs is a subpicture ID,
the first set of coded video data units comprise a first set of video coding layer network abstraction layer (VCL NAL) units, and
the second set of coded video data units comprise a second set of VCL NAL units.

6. A method of video processing, comprising:
determining, at a second device, a metadata file, the metadata file comprising a list of region identities (IDs) for indicating a first set of coded video data units in each picture of a first video representing a target picture-in-picture region which is replaceable by a second set of coded video units in a second video; and
transmitting the metadata file to a first device.

7. The method of claim 6, wherein the list of region IDs is an attribute of an element in a descriptor in the metadata file.

8. The method of claim 7, wherein the attribute is a regionIds.

9. The method of claim 6, wherein one region ID in the list of region IDs allows the first set of coded video data units having the region ID in the first video replaced with the second set of coded video unit having the region ID in the second video before decoding the first video.

10. The method of claim 6, wherein a region ID in the list of region IDs is a subpicture ID,
the first set of coded video data units comprise a first set of video coding layer network abstraction layer (VCL NAL) units, and
the second set of coded video data units comprise a second set of VCL NAL units.

11. An apparatus for processing video data comprising a processor and a non-transitory memory with instructions thereon, wherein the instructions upon execution by the processor, cause the processor to
receive, by a first device, a metadata file from a server; and
determine, from the metadata file, a list of region identities (IDs) for indicating a first set of coded video data units in each picture of a first video representing a target picture-in-picture region which is replaceable by a second set of coded video units in a second video.

12. The apparatus of claim 11, wherein the list of region IDs is an attribute of an element in a descriptor in the metadata file.

13. The apparatus of claim 12, wherein the attribute is a regionIds.

14. The apparatus of claim 11, wherein one region ID in the list of region IDs allows the first set of coded video data units having the region ID in the first video replaced with the second set of coded video unit having the region ID in the second video before decoding the first video.

15. The apparatus of claim 11, wherein a region ID in the list of region IDs is a subpicture ID,
the first set of coded video data units comprise a first set of video coding layer network abstraction layer (VCL NAL) units, and
the second set of coded video data units comprise a second set of VCL NAL units.

16. A non-transitory computer-readable storage medium storing instructions that cause a processor to:
determine, at a second device, a metadata file, the metadata file comprising a list of region identities (IDs) for indicating a first set of coded video data units in each picture of a first video representing a target picture-in-picture region which is replaceable by a second set of coded video units in a second video; and
transmit the metadata file to a first device.

17. The non-transitory computer-readable storage medium of claim 16, wherein the list of region IDs is an attribute of an element in a descriptor in the metadata file.

18. The non-transitory computer-readable storage medium of claim 17, wherein the attribute is a regionIds.

19. The non-transitory computer-readable storage medium of claim 16, wherein one region ID in the list of region IDs allows the first set of coded video data units having the region ID in the first video replaced with the second set of coded video unit having the region ID in the second video before decoding the first video.

20. The non-transitory computer-readable storage medium of claim 16, wherein a region ID in the list of region IDs is a subpicture ID,
the first set of coded video data units comprise a first set of video coding layer network abstraction layer (VCL NAL) units, and
the second set of coded video data units comprise a second set of VCL NAL units.
